(19) United States
(12) Patent Application Publication
(10) Pub. No.: US 2008/0030395 A1
(43) Pub. Date: Feb. 7, 2008

(54) Single bit pseudomonopulse tracking system for frequency agile receivers

(75) Inventors: Earl Knick, Melbourne, FL (US); James K. Conn, Indialantic, FL (US); Larry P. Serulneck, Viera, FL (US)

Correspondence Address: HARRIS CORPORATION;C/O DARBY & DARBY PC, P.O. BOX 770, CHURCH STREET STATION, NEW YORK, NY, 10008-0770, US

(73) Assignee: HARRIS CORPORATION, Melbourne, FL (US)

(21) Appl. No.: 11/500,244

(22) Filed: Aug. 7, 2006

(51) Int. Cl. G01S 13/44; G01S 13/66

(52) U.S. Cl. 342/80; 342/95; 342/140; 342/141; 342/149; 342/152; 342/154; 342/156

(57) ABSTRACT

A system for generating a pseudomonopulse tracking error includes an antenna system (401) that generates a sum antenna beam and a difference antenna beam. The sum antenna beam has a pattern with a peak gain on the boresight axis, and the difference antenna beam has a pattern that is circularly symmetric and forms a null about the boresight axis. The difference antenna beam has a relative phase that varies 360 degrees around the boresight axis. A differential phase dispersion is provided as between the sum and difference RF channels (405, 407) to providing a rotating scanning plane (702).

### BACKGROUND OF THE INVENTION

1. Statement of the Technical Field

The invention concerns pseudomonopulse tracking systems, and more particularly, systems that reduce the complexity of scanner circuitry necessary for producing tracking error signals.

2. Description of the Related Art

Many types of RF communication systems utilize directional antennas. While directional antennas offer numerous advantages, they generally must be pointed toward a remote transceiver station in order to achieve maximum communication efficiency. For example, pointing the directional antenna toward a remote transceiver station allows the communication system to achieve the best possible signal to noise value for the radio link and permits optimization of various other communication parameters such as bit-error-rate. Where the remote transceiver station is a moving target, such as a satellite, some method must be provided to continuously ensure that the directional antenna is pointed in the right direction.

In order to solve the foregoing problem, many systems use what is known as pseudo-monopulse tracking. Pseudo-monopulse tracking systems are those in which tracking of the signal source is accomplished by comparing signals received through overlapping patterns or lobes of the receiver antenna. The comparison helps to determine any discrepancy between the pointing direction of the antenna and the actual direction of the signal source. Any discrepancy is reduced to pointing or tracking error signals used for correcting the pointing direction of the antenna.

In a conventional pseudomonopulse tracking system an antenna system is used to generate at least two distinct antenna patterns. Generally, these two patterns are referred to as a sum and difference pattern. The sum beam usually comprises a peak gain on boresight, whereas the difference beam generally exhibits a null on boresight. In conventional tracking systems, the sum channel and difference channel are typically communicated to a coupler, where a portion of a received signal in the difference channel is coupled to the received signal in the sum channel. Combining the sum and difference channel beams in this way results in a squinting of the sum channel beam at some angle slightly displaced from boresight. In other words, the peak gain of the sum channel appears offset slightly from boresight when the difference channel is coupled to the sum channel. The extent of the angular displacement will depend on the amount of coupling.

A phase shifter is typically used to control the squint direction relative to boresight. In order to control the beam squint process described herein, one or more control bits are typically used. For example, a tracking system that operates in only a single axis (azimuth) would require one control bit to squint the beam left (0) and right (1) of boresight. In actual practice, it is usually necessary for a tracking system to track a target along two axes (usually azimuth and elevation). For such systems, two data bits are generally needed to control the system. The two data bits provide 4 control states, i.e. two beam scan positions for two axes.

The phase shifter device used to scan or squint the beam as described herein is selectively controlled to quickly vary the phase between two positions. A single phase shifter can be used for each axis. One or more phase shifters can be used to provide 0° phase shift and 180° phase shift for any two orthogonal planes, such as azimuth and elevation. Switching the phase shifter between these two positions results in the two squinted sum channel antenna patterns for each plane. Some antenna systems use a slightly different arrangement as compared to that which has been thus far described. For example, some existing systems generate circularly symmetric amplitude beam for the difference antenna in which the phase rotates 360° around boresight. In the case of such circularly symmetric amplitude beams, a 0°/180° and 90°/270° phase shift are used to form two scanned beams in orthogonal planes.

Tracking accuracy in pseudomonopulse tracking systems requires tight control over phase variations as between the sum and difference channels. Still, phase changes as between the channels are practically inevitable as the temperature and frequency is varied. These phase variations can be calibrated out of the system using various known techniques. For example, variable phase shifters are often used for this purpose. The phase shifters are actively controlled by a suitable microprocessor or control circuit in order to remove any phase variations that may occur in the system. A look up table can be used to store calibration data which can correct for phase errors which occur with variations in operating frequency and temperature. While such systems can be effective for reducing phase errors, they nevertheless add complexity to the system. For example, additional control bits are generally needed to perform such phase error correction.

From the foregoing, it will be understood that conventional pseudomonopulse tracking systems can involve a substantial degree of complexity, with two control bits needed for beam scanning, additional control bits used for frequency/temperature phase error correction, calibration tables, knowledge of frequency, and sensors for determining real time temperature information.

### SUMMARY OF THE INVENTION

The invention concerns a method for generating a pseudomonopulse tracking error signal. The method includes forming with an antenna system a sum antenna beam pattern and a difference antenna beam pattern. The sum antenna beam pattern has a peak gain on a boresight axis of the antenna system. The difference antenna beam pattern is formed so that it has a gain that is circularly symmetric and includes a null about the boresight axis. The phase response of the difference antenna beam is configured so that it varies 360 degrees around the boresight axis. The method further includes forming a differential phase dispersion between the sum antenna beam pattern and the difference antenna beam pattern. For example, the phase dispersion can be interposed by inserting a differential length of transmission line in an output of the antenna system forming the sum antenna beam pattern or the difference antenna beam pattern.

With the antenna system arranged in this way, the method continues by receiving with the antenna system a plurality of RF signals transmitted from a remote transmitter. For example, the remote transmitter can be onboard an earth orbiting satellite. The RF signals are advantageously selected so that they are transmitted on a plurality of different frequencies defined within a predetermined band of hop frequencies. For example, these frequencies can correspond to a set of frequencies assigned to a frequency agile communications system.

The method continues by generating a pseudomonopulse tracking error signal. The pseudomonopulse tracking error signal is useful for adjusting an orientation of the antenna system so that the boresight axis of the antenna system is constantly pointed in a direction toward the transmitter. The process of generating the pseudomonopulse tracking error signal involves comparing an output of the sum antenna beam pattern and the difference antenna beam pattern produced as a result of the receiving step. According to one aspect of the invention, a phase of the signals received on the difference antenna beam pattern is selectively shifted between 0 degrees and 180 degrees to squint the difference beam within a scanning plane that rotates about the boresight axis. Notably, the phase dispersion designed into the antenna system described herein, and the varying frequency of each transmitted signal, cooperate to automatically rotate the scanning plane in response to the phase dispersion. In particular, the method includes rotating the scanning plane in accordance with a varying phase dispersion associated with the plurality of different frequencies.

The foregoing process will provide for each transmitted signal a pseudomonopulse tracking error signal associated with a particular scanning plane. Notably, the scanning plane will not necessarily directly correspond to azimuth or elevation. Instead, the scanning plane will be oriented at some arbitrary angle defined between zero and 360 degrees around boresight. The actual instantaneous angle of the rotating plane will be determined based on a frequency of a received signal and the relative location of the transmitter relative to boresight. Regardless of the instantaneous angle of the rotating scanning plane, it can be advantageous to decompose the pseudomonopulse tracking error signal into error vectors in the azimuth and elevation planes. Accordingly, the method can continue by automatically decomposing the pseudomonopulse tracking error signal into a pair of orthogonal tracking error vectors.

The foregoing arrangement for generating pseudomonopulse tracking error signals is be advantageous because the pseudomonopulse tracking error signal can be generated exclusively by means of a single control bit. For example, the single control bit can be used to select a 0°/180° phase shift in the difference channel. In an alternative embodiment, the single control bit can simply control an RF switch to selectively activate and deactivate the difference beam.

The invention also concerns a system for generating a pseudomonopulse tracking error. The system is comprised of an antenna system that generates a sum antenna beam and a difference antenna beam as described above. The sum antenna beam has a pattern with a peak gain on the boresight axis, and the difference antenna beam has a pattern that is circularly symmetric and forms a null about the boresight axis. The difference antenna beam has a relative phase that varies 360 degrees around the boresight axis.

The antenna system includes an antenna feed for communicating signals received on the sum antenna beam to a sum RF channel and for communicating signals received on the difference antenna beam to a difference RF channel. A scanning means is coupled to the antenna feed for scanning the difference beam in a scanning plane that automatically rotates about a boresight axis of the antenna system in response to a variation in frequency among signals received on the antenna system. The system also includes an error signal processor configured for generating a pseudomonopulse tracking error signal responsive to the scanning means. The error signal processor also advantageously includes a computer processor for automatically decomposing the tracking error signal into a pair of orthogonal tracking error vectors.

The scanning means includes a phase dispersion device interposed in one or more of a sum RF channel and a difference RF channel. According to one aspect of the invention, the phase dispersion device is formed of a predetermined differential length of an RF transmission path of the sum RF channel as compared to the RF transmission path of the difference RF channel. For example, the phase dispersion device can be a simple transmission line that has a first length in the sum channel and different length in the difference channel. Advantageously, the difference in length between the two transmission paths is at least 90 electrical degrees at every frequency within a predetermined range of frequencies. Such a difference can be useful for ensuring that the pseudomonopulse tracking error always decomposes into relatively large magnitude vectors in each of the azimuth and elevation planes.

A 0°/180° phase shifter is advantageously interposed in one or more of the sum RF channel and the difference RF channel. According to an embodiment of the invention, the phase shifter can be shifted between the two alternate phase values by means of a single control bit. The phase shifter can be used in this way to squint the difference beam to achieve a scanning effect as previously described. Use of a single control bit to perform this scanning function, while still producing azimuth and elevation tracking error data, is an advantage over conventional systems that use at least two control bits. The invention reduces the complexity of the scanning system. For example it reduces the number of control wires, the number of control circuits, and the number of slip rings in the antenna pedestal.

### BRIEF DESCRIPTION OF THE DRAWINGS

Embodiments will be described with reference to the following drawing figures, in which like numerals represent like items throughout the figures, and in which:

FIG. 1 is a block diagram of a pseudo-monopulse antenna tracking system of the prior art.

FIG. 2 is a plot showing sum and difference antenna patterns that can be generated by the feed and combiner in FIG. 1.

FIG. 3 is a plot showing a sum beam squinted to the left and the right of boresight.

FIG. 4 is a block diagram showing a pseudomonopulse antenna tracking system that is useful for understanding the invention.

FIG. 5 is a block diagram of a combiner used in the pseudomonopulse antenna tracking system in FIG. 4.

FIG. 6 is a drawing that is useful for understanding a scan plane in a pseudomonopulse antenna tracking system.

FIG. 7 is a drawing that is useful for understanding a rotating scan plane.

### DETAILED DESCRIPTION OF THE PREFERRED EMBODIMENTS

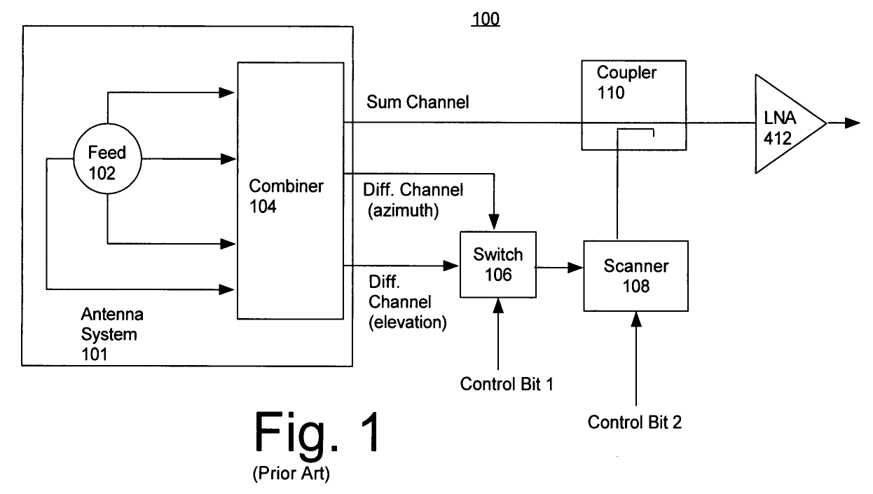

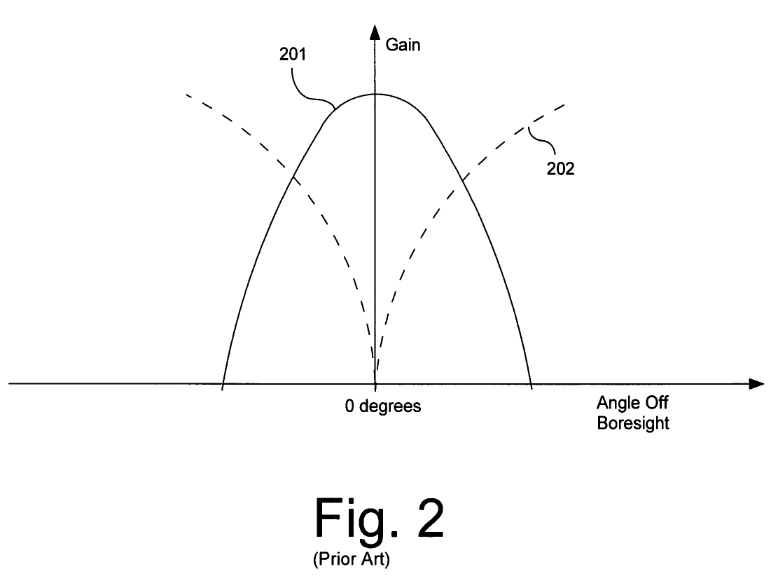

FIG. 1 is a block diagram that shows a conventional pseudo-monopulse antenna tracking (PMAT) system. The PMAT system 100 includes a conventional antenna system 101 comprised of a feed 102 and a combiner 104. Those skilled in the art will readily appreciate that the feed 102 and the combiner 104 can be selected to operate cooperatively to produce sum and difference antenna channels as shown in FIG. 2. The sum and difference antenna channels are conventionally associated with certain types of well known antenna patterns which are substantially as shown in FIG. 2. Combiner 104 typically includes one or more conventional hybrid junctions used for RF dividing and combining functions. Those skilled in the art will appreciate that the particular type of combiner 104 used in a particular instance will depend on a variety of factors, including the type of antenna selected and feed that is used. Further, it will be appreciated that the antenna system 101 can generate a difference channel representing a difference antenna pattern in an azimuthal plane and a second difference pattern aligned in the plane of elevation for the antenna.

Referring again to FIG. 1, it can be observed that the sum channel and difference channel are each communicated to a coupler 110, where a portion of a received signal in the difference channel can be coupled to the received signal in the sum channel. The actual amount of coupling will be selected by a system designer and will depend on a number of factors. Typical coupling values for these types of system can range between 6 dB and 16 dB. Regardless of the specific coupler selected, combining the sum and difference channel beams in this way results in a squinting of the sum channel beam at some angle slightly displaced from boresight. In other words, when the sum channel signal is measured at the output of the coupler 110, the peak gain of the sum channel appears offset slightly from boresight when the difference channel is coupled to the sum channel. The extent of the angular displacement will depend on the amount of coupling.

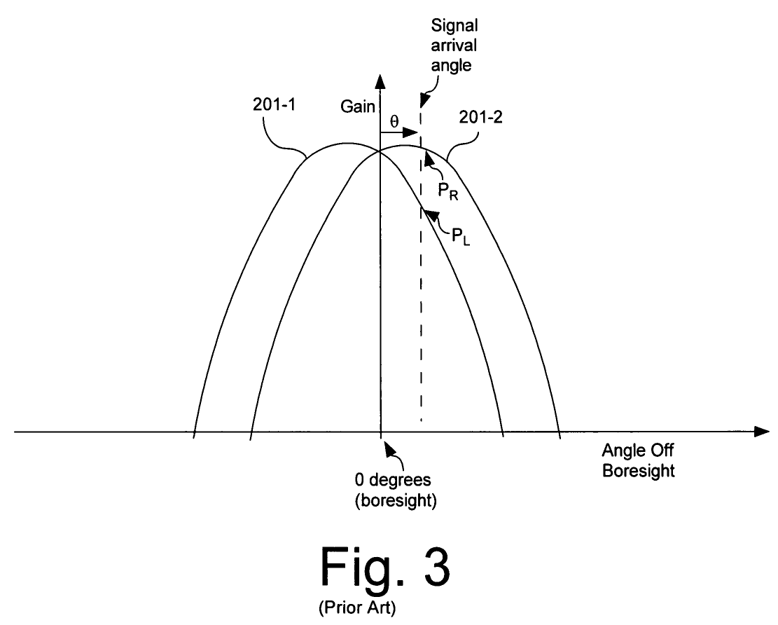

A scanner 108 is used to control the squint direction relative to boresight. Typically, the scanner 108 will be comprised of a variable phase shifting device. For example, the scanner 108 can be selectively controlled to quickly vary the phase between two positions defined as a 0° phase shift and 180° phase shift. Switching the scanner between these two positions results in the two sum channel antenna patterns 201-1, 201-2 shown in FIG. 3 at the output of coupler 110.

Referring now to FIG. 3, there is shown a drawing that is useful for understanding how a pseudomonopulse tracking error is conventionally generated in a particular plane (azimuth or elevation). In FIG. 3, it can be observed that a signal arriving at some angle θ will be received in beam 201-1 at a power level P_{R}. In contrast, the same signal will be received in beam 201-2 at a power level P_{L}. It will be appreciated that in FIG. 3, the relative difference in received power or the ratio between the two power levels P_{R} and P_{L} can be used to generate an error signal that uniquely defines the angle θ. For example, the tracking error signal can be defined as follows:

$$Tracking Error Signal = \hat{e} - \frac{{\hat{P}}_{R} - {\hat{P}}_{L}}{{\hat{P}}_{R} + {\hat{P}}_{L}}$$

where \hat{P}_{R} and \hat{P}_{L} are the average values of P_{R} and P_{L}, respectively. The value of P_{R} and P_{L} can be measured during the occurrence of a single pulse to minimize the effect of any variations in the transmission path. The output of coupler 110 can be provided to a low-noise amplifier 112 to provide some signal gain. Thereafter, the signal can be coupled to a tracking control system where the tracking error can be calculated. Thereafter the tracking error signal is used in a look-up-table to determine a value for E. Once this error angle is determined, it can be used to modify a position of an antenna to compensate for the angle θ, thereby ensuring that antenna boresight is pointed directly at the target.

Thus far, the conventional pseudo-monopulse tracking system in FIG. 1 has been described with respect to a single difference channel. A single difference channel can be satisfactory for tracking a target in a single plane. In practice, however, it is common to provide a difference channel output from combiner 104 aligned in the azimuth and elevation planes. As shown in FIG. 1, an RF switch 106 can be used to selectively determine which of these two difference channel signals are communicated to the scanner 108. The two difference channels can be used in the manner previously described herein to produce a tracking error signal for the antenna azimuth and elevation.

The RF switch 106 selectively controls whether the sum channel is coupled with a difference antenna pattern aligned in the azimuth plane or a difference antenna pattern aligned with the elevation plane. Like the phase shifter described above, the RF switch requires at least one control bit. This control bit is used to selectively alternate between the two difference antenna patterns for the purpose of generating tracking error signal vectors respectively aligned with the azimuth and elevation planes. From the foregoing, it will be understood that it has generally been necessary to provide at least two control bits for generating pseudomonopulse tracking error data where it is desired to includes error vectors in both an azimuth and elevation plane. In FIG. 1, these are shown as Control Bit 1 and Control Bit 2.

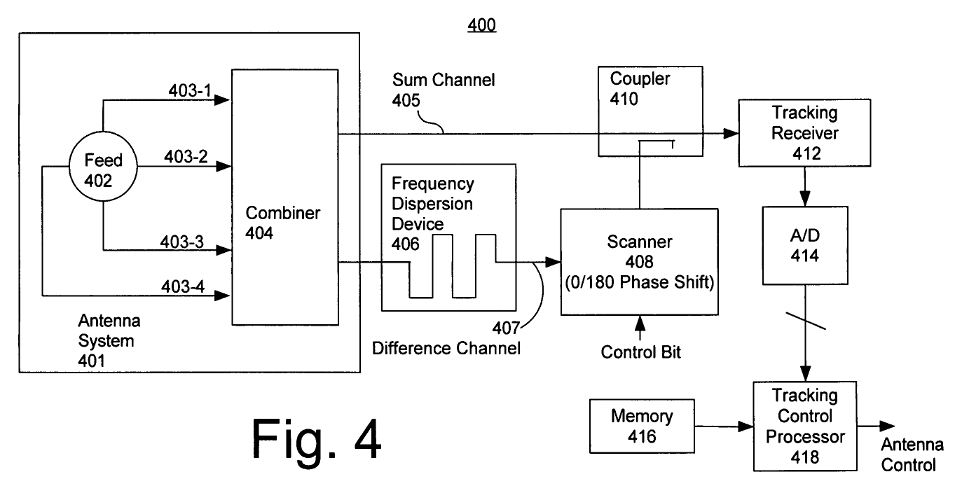

Referring now to FIG. 4, there is shown a block diagram that is useful for understanding a pseudomonopulse tracking system 400 for frequency agile receivers which can be controlled by means of only a single control bit. The pseudomonopulse tracking system in FIG. 4 includes an antenna system 401. The antenna system 401 is comprised of a feed 402 for a microwave horn antenna and a combiner 404. As used herein, the term boresight refers to an axis aligned with the elongated length of a microwave horn antenna excited by feed 402.

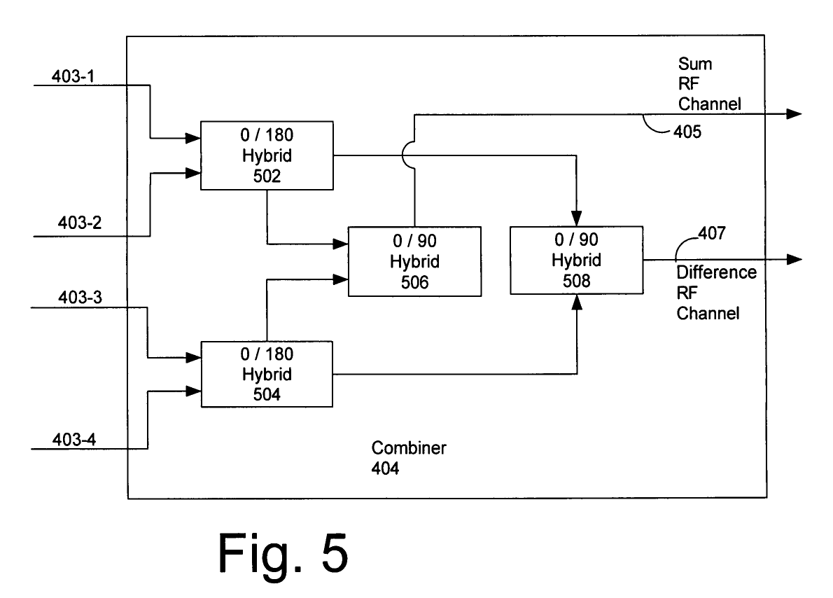

The output of the combiner 404 includes a sum RF channel 405 and difference RF channel 407. Combiner 404 is shown in greater detail in FIG. 5. In order to generate the sum RF channel 405 and difference RF channel 407, inputs 403-1, 403-2, 403-3, 4034 from the feed 402 are connected to 0°/180° hybrids 502, 504 in combiner 404. The outputs of hybrids 502, 504 are connected to 0°/90° hybrids 506, 508 as shown. The outputs of hybrid 506 and 508 comprise the sum and difference RF channels, respectively.

According to an embodiment of the invention antenna feed 402 is advantageously selected so that it excites a TE11 mode and a TM01 within a band of frequencies over which the antenna system 401 will be used. The TE11 mode is used to form the sum channel antenna pattern and the TM01 mode is used to form the difference channel antenna pattern. As with the antenna patterns used in conventional pseudomonopulse tracking systems, the sum channel has a peak gain aligned with the boresight of the microwave antenna horn. However, the TM01 mode provides an antenna pattern that has certain unique properties hereinafter described which can be used advantageously to reduce the complexity of the tracking system.

In particular, with a properly designed feed 402 arranged to excite the TM01 mode, the resulting difference beam antenna pattern is circularly symmetric in amplitude, with a null on boresight. The phase of signals as received in the TM01 difference pattern is also significant. The phase of a received signal on the difference pattern will advantageously vary depending on its location relative to boresight. More particularly, the relative phase of a received signal will vary in a direct relationship that corresponds with relative spatial degrees as the position of the source of the signal varies around boresight. Accordingly, a received signal received on the difference antenna pattern will vary 360 electrical degrees in correspondence with its relative spatial angle around boresight. This electrical phase rotation maps directly to the angular spatial angular deviation corresponding to a position of an RF source as it moves circumferentially around boresight in a plane aligned perpendicular to antenna boresight.

From the foregoing it will be appreciated that at any given spatial angle around boresight, the phase of the received signal in the difference channel will have a known fixed relationship to the phase of the TE11 sum channel beam. This characteristic of the antenna system 401 can be used in a manner which shall hereinafter be described in order to provide a pseudomonopulse tracking system which facilitates a control system that is simplified as compared to that which was previously attainable in the prior art for dual axis (e.g., elevation and azimuth) pseudomonopulse tracking systems.

Referring again to FIG. 4, it can be observed that the sum RF channel 405 is connected to a coupler 410. The connection between these devices will typically comprise a transmission line, such as a waveguide. The transmission line will have an electrical length that is known.

The difference RF channel 407 from the combiner is communicated to a frequency dispersion device 406. Frequency dispersion refers to the property of microwave transmission lines that have different group velocity versus frequency. The characteristic impedance Zₒ of a transmission line is often approximated as some real value that is independent of frequency. In reality, the characteristic impedance frequency-dependent and complex. Consequently, group velocity or wave velocity will be some complex value, which is a function of frequency. This known frequency-dependent variation in the wave velocity is called “dispersion.” In effect, different frequencies propagating along a transmission line will travel at different speeds. Depending on the length of the transmission line, this dispersion effect will manifest itself as a frequency dependent variable phase shift. Those skilled in the art will appreciate that the exact amount of dispersion which occurs will be a function of the complex impedance for the particular transmission line. Accordingly, the relative amount of dispersion can be determined for each frequency.

The exact amount of dispersion introduced by the frequency dispersion device 406 is not critical, provided that the frequency dispersion characteristics of the device are known. Still, it can be advantageous to provide a frequency dispersion device that introduces a substantial variation in phase shift across a band of frequencies over which a frequency agile receiver is designed to operate. For example it is desirable to provide at least about 90 degrees of difference in phase shift for frequencies at the lowest end of the operating band as compared to frequencies at the highest end.

According to one embodiment of the invention, the frequency dispersion device 406 is implemented as a predetermined length of transmission line. The characteristic impedance and length of the transmission line are selected to provide a desired amount of relative dispersion for the various frequencies spread across the operating band used for the frequency agile receiver. Alternatively, the frequency dispersion device could be an active device. For example, by sampling an incoming RF signal, or by utilizing a priori knowledge, it is possible to determine the instantaneous frequency of a received signal in a frequency agile receiver. This information could be used to control a variable phase shifter. Still, the transmission line approach can be preferred in some instances because of its simplicity and low cost. In any case, the presence of the frequency dispersion device in the difference channel is used to produce a differential phase dispersion in said difference channel relative to said sum channel. As used herein, the term differential phase dispersion refers to a difference in an amount of phase dispersion created in the sum channel versus the difference channel. In this regard, those skilled in the art will appreciate that the frequency dispersion device 406 could also be positioned in the sum channel 405 instead of the difference channel 407 to achieve a similar effect.

A scanner 408 is also provided in the signal path of difference channel 407. For example, the scanner can be disposed at the output of the frequency dispersion device 406 as shown in FIG. 4. The scanner 408 selectively modifies the nature of the difference channel signal that is applied to the coupler 410. In this regard, scanner 408 can be implemented as a selectable 0°/180° phase shifter. The phase shifter can be operated in a manner which is similar to pseudomonopulse tracking systems to squint the antenna beam some predetermined angle θ away from boresight. Alternatively According to another embodiment of the invention, the phase shifter is a simple RF switch.

Referring again to FIG. 4, the output from the scanner 408 is connected to the coupler 410. Coupler 410 combines a predetermined portion of the difference channel signal with the sum channel signal. The resulting output will be a function of the relative amplitude of the sum channel and the difference channel. Significantly, however, the output will also be a function of the relative phase of the two channels, which varies with frequency by means of frequency dispersion device 406. The output of coupler 410 is communicated to the tracking receiver 412. The tracking receiver 412 includes an RF amplitude detector circuit which determines the signal amplitude of the coupler output. The output amplitude will uniquely define the position of RF transmission source in the difference pattern beam on a pulse by pulse basis.

The output of the tracking receiver 412 is communicated to an A/D converter 414 which provides a digital output that is representative of the RF signal amplitude from coupler 410. This digital output is communicated to a microprocessor 416 for further processing.

In a conventional pseudomonopulse tracking system 100, it is often important to phase match the sum channel and difference channel to provide a proper error signal output from coupler 110. In contrast, in the pseudomonopulse tracking system 400 shown in FIG. 4, frequency dispersion device 406 intentionally provides a frequency dependent variable phase in the difference channel 407, relative to signals in the sum channel 405. This frequency dependent variable phase is used advantageously in a frequency agile receiver.

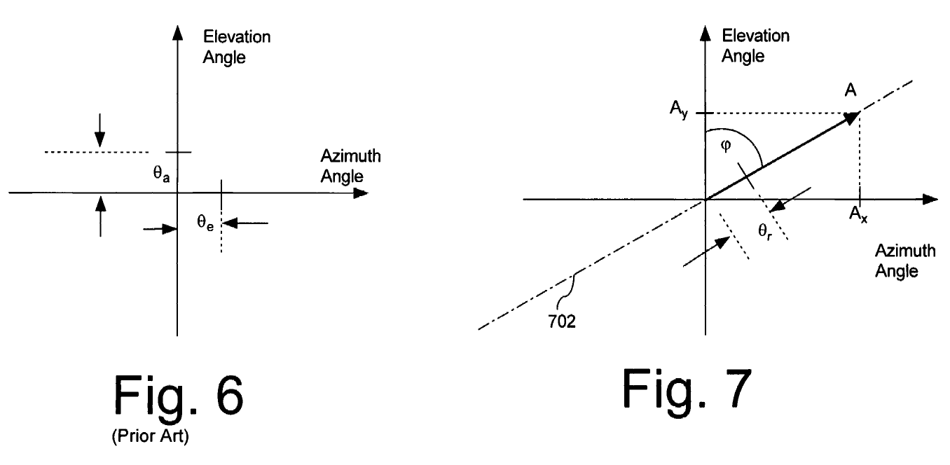

As shown in FIG. 3, a conventional pseudomonopulse tracking system will squint an antenna beam in an azimuth plane by some angle θ to determine a position of an RF source on that plane relative to antenna boresight. A similar process is conventionally used to shift a difference pattern aligned with the plane of elevation to determine a position of the RF source on that plane relative to antenna boresight. This concept is illustrated in FIG. 6 which shows the squint angles θₐ and θₑ in the azimuth and elevation planes, respectively. In one instance the antenna beam is scanned in the azimuth plane and in the other instance, the antenna beam is scanned in the elevation plane.

FIG. 7 is a drawing that is useful for understanding a scanning plane generated by the system in FIG. 4. It can be observed in FIG. 7 that, like conventional systems, the antenna beam is scanned by a squint angle. In this case, the squint angle is defined as θᵣ. However, in contrast to conventional tracking systems, the scanning plane 702 of the difference antenna pattern is not aligned with the azimuth or elevation plane. Instead, the scanning plane 702 is variable. The scan plane will rotate or vary about the antenna boresight to an angle φ as shown in FIG. 7. Significantly, the exact angle of rotation φ of the scan plane 702 in FIG. 7 will vary in accordance with an angular phase shift introduced by the frequency dispersion device 406. Since the phase shift introduced by the frequency dispersion device 406 will vary as a function of frequency, it will be understood the scan plane will also vary as a function of a frequency.

The foregoing characteristic of the system in FIG. 4 can be particularly useful in frequency agile receiver systems where the frequency of the received RF signals is constantly varying within a predetermined band of frequencies. In particular, the constantly varying frequency can be used to automatically vary the angle φ of the scanning plane for the difference beam. For example, the frequency dispersion device 406 can be designed to cause a relative phase shift that varies from 0° at the lowest frequency in a predefined band of hop frequencies, and up to 360° at the highest frequency in a predefined band of hop frequencies. This would cause the scanning plane 702 to rotate 360° over a period of time as the received signal progresses through the various hop frequencies. Alternatively, the system can also be designed so that the scanning plane varies over a smaller range of angles. For example, the frequency dispersion device can be designed to vary the phase over an angle of 90°, thereby causing the scanning plane to rotate over that angular range.

Referring again to FIG. 4, the output of A/D converter 414 is advantageously communicated to a tracking control processor (TCP). TCP 414 can be comprised of a programmable microprocessor, general purpose computer programmed with a set of instructions or any other electronic circuitry suitable for performing the functions as described herein. According to one embodiment, the control processor is a microprocessor programmed with a suitable set of instructions for performing the various functions described herein. According to an embodiment of the invention a suitable data store, such as memory 416 is also provided.

The digital output from A/D converter 414 is communicated to TCP 418. As shown in FIG. 7, the digital output will be some amplitude value corresponding to a vector A as shown in FIG. 7. The angle φ associated with vector A is determined by the TCP 418 based on the frequency of the received signal associated with vector A. According to one embodiment, the instantaneous frequency of a received pulse from a remote RF source can be determined based on a priori information. For example, the instantaneous information relating to the current hop frequency can be stored in a data store such as memory 416. Alternatively, the incoming frequency on the sum or difference channel can be sampled to rapidly determine the frequency of each incoming signal. Regardless of the exact means by which the instantaneous hop frequency of the received signal is determined, the information is advantageously used to determine the corresponding phase shift introduced by the frequency dispersion device. This phase shift information can be used to determine the instantaneous angle of the scanning plane φ. The phase shift introduced by the frequency dispersion device for each pulse can be provided directly to the TCP 418. The phase shift can be determined from a look up table based on information relating to the instantaneous frequency. Yet another alternative would be to calculate the phase shift introduced by the frequency dispersion device as the frequency of each pulse is determined.

Once the angle φ is determined, the amplitude of vector A can be decomposed along the azimuth and elevation planes. In FIG. 7, vector A is decomposed into its component vectors Aₓ and A_{y} which are aligned with the azimuth and elevation axis. The process of decomposing vector A into its component vectors can be performed using simple trigonometric equations. Alternatively, a look up table can be used to determine the component vectors Aₓ and A_{y} based on a particular amplitude of vector A and an angle φ.

TCP 414 includes data communications ports for communicating control signals to one or more component systems forming the antenna system 401. The communications ports can be coupled to any suitable type of conventional computer data communication bus. The computer data communication bus can be used to communicate control signals from the TCP 414 to an antenna positioning device. The antenna positioning device (not shown) can be used to correct a boresight direction of the antenna so that is more closely aligned with an RF signal source. The error correction signal is determined by the TCP 418 based on the values of component vectors Aₓ and A_{y}. TCP 414 can also control a control bit used to control scanner 408.

A significant advantage of the arrangement described herein with regard to FIG. 4 is that only a single control bit is needed to provide pseudomonopulse tracking in two orthogonal planes. Conventional systems generally require the use of at least two control bits to provide similar tracking capabilities in the azimuth and elevation plane. The reduction in control bits reduces the cost and complexity of the system.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

We claim:

1. A method for generating a pseudomonopulse tracking error signal, comprising:
forming with an antenna system a sum antenna beam pattern having a peak gain on a boresight axis;
forming with said antenna system a difference antenna beam pattern that has a gain that is circularly symmetric and forms a null about said boresight axis, and has a relative phase that varies 360 degrees around said boresight axis;
interposing a differential phase dispersion as between said sum antenna beam pattern and said difference antenna beam pattern;
receiving on said antenna system a plurality of RF signals transmitted from a remote transmitter on a plurality of different frequencies defined within a predetermined band of hop frequencies;
generating a pseudomonopulse tracking error signal by comparing an output of said sum antenna beam pattern and said difference antenna beam pattern produced as a result of said receiving step.

2. The method according to claim 1, wherein said phase dispersion is interposed by inserting a differential length of transmission line in an output of the antenna system forming the sum antenna beam pattern or the difference antenna beam pattern.

3. The method according to claim 1, further comprising selectively shifting a phase of said signals received on said difference antenna beam pattern between 0 degrees and 180 degrees to scan said difference beam.

4. The method according to claim 1, further comprising scanning said difference beam in a plane that rotates about said boresight axis.

5. The method according to claim 4, further comprising rotating said plane in response to said phase dispersion.

6. The method according to claim 5, further comprising rotating said plane in accordance with a varying phase dispersion associated with said plurality of different frequencies.

7. The method according to claim 6, further comprising automatically decomposing said tracking error signal into a pair of orthogonal tracking error vectors.

8. The method according to claim 6, wherein an instantaneous angle of said rotating plane is determined based on a frequency of a received signal.

9. The method according to claim 1, further comprising controlling an implementation of a system for generating said pseudomonopulse tracking error signal in an azimuth and elevation plane exclusively by means of a single control bit.

10. The method according to claim 9, further comprising selectively controlling with said single control bit a 0°/180° phase shift in said difference channel

11. The method according to claim 9, further comprising selectively controlling with said single control bit an RF switch to selectively activate and deactivate said difference beam.

12. A system for generating a pseudomonopulse tracking error, comprising:
an antenna system comprising means for generating a sum antenna beam and a difference antenna beam;
an antenna feed for communicating signals received on said sum antenna beam to a sum RF channel and for communicating signals received on said difference antenna beam to a difference RF channel;
a scanning means coupled to said antenna feed for scanning said difference beam in a plane that automatically rotates about a boresight axis of said antenna system in response to a variation in frequency among a plurality of signals received on said antenna system.

13. The system according to claim 12, further comprising an error signal processor configured for generating a tracking error signal responsive to said scanning means.

14. The system according to claim 13, wherein said error signal processor further comprises computer processing means for automatically decomposing said tracking error signal into a pair of orthogonal tracking error vectors.

15. The system according to claim 12, wherein said sum antenna beam has a pattern with a peak gain on said boresight axis, and said difference antenna beam has a pattern that is circularly symmetric and forms a null about said boresight axis.

16. The system according to claim 15, wherein said difference antenna beam has a relative phase that varies 360 degrees around said boresight axis.

17. The system according to claim 12, wherein said scanning means comprises a phase dispersion device interposed in at least one of a sum RF channel and a difference RF channel.

18. The system according to claim 17, wherein said phase dispersion device is formed of a predetermined differential length of an RF path of said difference RF channel as compared to said sum RF channel.

19. The system according to claim 18, wherein said phase dispersion device comprises a length of transmission line.

20. The system according to claim 18, further comprising a 0°/180° phase shifter interposed in at least one of said sum RF channel and said difference RF channel.
